(19) United States
(12) Patent Application Publication
(10) Pub. No.: US 2014/0117644 A1
(43) Pub. Date: May 1, 2014

(54) Wheelchair Having Two Metastable Positions

(71) Applicant: Dave Paul, Eureka Springs, AR (US)

(72) Inventor: Dave Paul, Eureka Springs, AR (US)

(21) Appl. No.: 14/146,448

(22) Filed: Jan. 2, 2014

Related U.S. Application Data
(63) Continuation of application No. 29/420,863, filed on May 14, 2012.

(51) Int. Cl. A61G 5/10

(52) U.S. Cl. CPC A61G 5/1075
USPC 280/287

(57) ABSTRACT

A wheelchair having two metastable positions. The wheelchair comprises a seat, a carriage, and a coupling. The seat comprises a seat frame having a front seat coupling axle and a rear seat coupling axle, and a flexible material coupled to the seat frame that transfers a weight of a user to the seat frame. The carriage comprises a front carriage coupling axle and a rear carriage coupling axle. The coupling comprises a right front tubular support, a left front tubular support, a right rear tubular support, and a left rear tubular support coupled by pivots to the axles of the seat and carriage. The tubular supports form two double rocker mechanisms, each double rocker mechanism constrained by stops to a range of rocking motion between a first metastable position and a second metastable position.

### CROSS-REFERENCE TO RELATED APPLICATIONS

This application is a continuation of and claims priority to and the benefit of U.S. design patent application 29/420,863, filed May 14, 2012, entitled “Wheelchair,” by Dave Paul, which is incorporated herein by reference in its entirety for all purposes.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

For some wheelchair users, particularly those who experience shoulder deterioration, weightshifts of their body in the wheelchair (relieving pressure on the ischium) may be challenging and painful.

### SUMMARY

In an embodiment, a wheelchair having two metastable positions is disclosed. The wheelchair comprises a seat portion, a carriage portion, and a coupling portion. The seat portion comprises a seat frame having a front seat coupling axle and a rear seat coupling axle, and a flexible material coupled to the seat frame that transfers a weight of a user to the seat frame. The carriage portion comprises a front carriage coupling axle and a rear carriage coupling axle. The coupling portion comprises a right front tubular support, a left front tubular support, a right rear tubular support, and a left rear tubular support. Each front tubular support comprises a pivot coupling to the front seat coupling axle and a pivot coupling to the front carriage coupling axle. Each rear tubular support comprises a pivot coupling to the rear seat coupling axle and a pivot coupling to the rear carriage coupling axle. The right front tubular support, the right rear tubular support, the carriage portion, and the seat frame form a first double rocker mechanism on a right-hand side of the wheelchair. The left front tubular support, the left rear tubular support, the carriage portion, and the seat frame form a second double rocker mechanism on a left-hand side of the wheelchair. Each of the double rockers is constrained by stops to a range of rocking motion, where the seat portion is in a first metastable position when the double rockers are stopped at a first limit of the range of rocking motion and is in a second metastable position when the double rockers are stopped at a second limit of the range of rocking motion.

In an embodiment, a wheelchair having two metastable positions is disclosed. The wheelchair comprises a seat portion, a carriage portion, and a coupling portion, wherein the coupling portion couples the seat portion to the carriage portion and is configured to restrict a positional relationship between the seat portion and the carriage portion to two metastable positions.

In an embodiment, a method of shifting between two metastable positions in a wheelchair is disclosed. The method comprises leaning forward in the wheelchair by an occupant of the wheelchair, gripping a rear wheel of the wheelchair or a wheel rim of the wheelchair by a hand of the occupant of the wheelchair, pushing against the rear wheel or wheel rim with the hand by the occupant of the wheelchair, whereby the wheelchair is shifted from a first metastable position to a second metastable position.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a view of a wheelchair according to an embodiment of the disclosure.

FIG. 2 is a view of the right side of the wheelchair according to an embodiment of the disclosure.

FIG. 3 is a view of the left side of the wheelchair according to an embodiment of the disclosure.

FIG. 4 is a view of the front of the wheelchair according to an embodiment of the disclosure.

FIG. 5 is a view of the back of the wheelchair according to an embodiment of the disclosure.

FIG. 6 is a view of the top of the wheelchair according to an embodiment of the disclosure.

FIG. 7 is a view of the bottom of the wheelchair according to an embodiment of the disclosure.

FIG. 8 is a view of the wheelchair showing additional associated features according to an embodiment of the disclosure.

FIG. 9 is a view of the right side of the wheelchair our new design showing additional associated features according to an embodiment of the disclosure.

FIG. 10 is a view of the left side of the wheelchair showing additional associated features of the wheelchair according to an embodiment of the disclosure.

FIG. 11 is a view of the front of our new design showing additional associated features according to an embodiment of the disclosure.

FIG. 12 is a view of the back of the wheelchair showing additional associated features according to an embodiment of the disclosure.

FIG. 13 is a view of the top of the wheelchair showing additional associated features according to an embodiment of the disclosure.

FIG. 14 is a view of the bottom of the wheelchair showing additional associated features according to an embodiment of the disclosure.

FIG. 15 is a view of the wheelchair shown in a tilt position according to an embodiment of the disclosure.

FIG. 16 is a view of the right side of the wheelchair shown in a tilt position according to an embodiment of the disclosure.

FIG. 17 is a view of the left side of the wheelchair shown in a tilt position according to an embodiment of the disclosure.

FIG. 18 is a view of the wheelchair shown in a tilt position and showing additional associated features according to an embodiment of the disclosure.

FIG. 19 is a view of the right side of the wheelchair shown in a tilt position and showing additional associated features according to an embodiment of the disclosure.

FIG. 20 is a view of the left side of the wheelchair shown in a tilt position and showing additional associated features according to an embodiment of the disclosure.

FIG. 21 is a view of the wheelchair shown transitioning from an upright position to a tilt position and showing additional associated features according to an embodiment of the disclosure.

### DETAILED DESCRIPTION

There are benefits to a lightweight wheelchair that can be manipulated independently to achieve pressure relief. For some wheelchair users, particularly those who experience shoulder deterioration, weightshifts (relieving pressure on the ischium) may be challenging and painful. In the same way that people without mobility limitations like to relax by getting into a different position, the same issues exist for those in wheelchairs. Active work causes blood flow to pressure points, e.g., points where the body weight of the wheelchair occupant is supported against the seat and/or back of the wheelchair. When the wheelchair user is less active, however, blood does not flow readily to these pressure points and pressure sores may develop at the pressure points if weightshifts are not done often enough. Some mobility impaired may avoid this by taking breaks on a couch, lounge chair, etc. This change of body position puts the person's weight on different areas as opposed to when they are seated in a wheelchair. But, shoulder pain keeps many from hopping in and out of their wheelchair to accomplish this. There are many more that for one reason or another are limited to only sitting in their wheelchair, and such is the need for a special cushion. Body position change for all these people has typically meant having to get a heavy, hospital-looking type of wheelchair that requires the assistance of an attendant. For once active, still fairly independent people this is a real slap in the face. They want to keep their lightweight wheelchair and appear as normal as possible. They want to be able to take care of themselves as much as possible and prefer a feeling of independence. Embodiments of the current disclosure may provide the benefits of body position change without the wheelchair user leaving the wheelchair or needing assistance.

Embodiments of the current disclosure are lightweight, rigid wheelchairs having a back which folds down and with rear wheels that may be quick release for ease of transport. This reflects a type of wheelchair often viewed as desirable by an active, independent person. Embodiments may provide the ability to transport and propel the chair with efforts typical of other lightweight wheelchairs while also providing the ability to shift positions to a more tilted state by a simple lean and push. In such embodiments, by leaning forward slightly and pushing against the rear wheels with their hands, the person's knees and the leg rest move forward and up while the back and the person's bottom move forward and down, putting the user in a tilted position which is excellent for pressure relief. The stability of the wheelchair is maintained by keeping the user's weight centered over the four points of contact made by the wheels. To return to an upright position the user may simply push straight down on the rear wheels.

Some embodiments of this disclosure use a PVC pipe and fittings type of construction to build an attractive, functional, customizable, durable lightweight wheelchair that consists of three main components—the lower portion which includes the rear wheels, casters and “I” frame; the upper portion which holds the occupant; and the four pipes connecting the two. By controlling the lengths of these pipes one can control the amount of forward movement, leg elevation and lean the user will be exposed to. This allows each wheelchair to be made to each individual's preferences.

While the PVC of some embodiments may be particularly suitable for children or for aquatic use, a wheelchair made from aluminum alloy or other lightweight pipe could be more practical in the sense of durability for heavier adults. A square frame, instead of an “I” frame for the lower portion, is an example of an aesthetic variation that would not affect the functional design of this wheelchair. Another variation could be an extendable or flip-up back for those who need more shoulder support when tilted than while sitting.

This disclosure teaches a wheelchair that an occupant of the wheelchair can shift unassisted to support his or her weight in a different position. Someone who spends a lot of time in a wheelchair, for example a permanently disabled person, may need to occasionally change the distribution of his or her weight so as to avoid development of pressure sores. The drawings attached hereto illustrate one embodiment of an innovative new wheelchair that promotes the wheelchair occupant shifting the chair portion of the wheelchair from an upright sitting position to a tilt position. In the upright sitting position, the weight of the occupant may be supported mainly on the underside of the thighs and on the buttocks of the occupant. In the tilt position, the weight of the occupant may be supported at different points and/or with a different distribution of weight force.

For purposes of description, the wheelchair may be abstractly divided into a seat portion, a carriage portion, and a suspension or coupling portion. The seat portion accepts the weight of the user or occupant of the wheelchair and may include a back area, a seat area, and a foot rest area. The carriage portion transfers the weight of the user and the wheelchair to the floor and/or ground and comprises a plurality of wheels that promote rolling mobility of the wheelchair and user. In an embodiment, the suspension or coupling portion couples the seat portion to the carriage portion. In an embodiment, the coupling portion may be said to restrict the range of motion between the seat portion and the carriage portion to two metastable states—an upright metastable state and a tilt metastable state. Said in other words, in an embodiment, the coupling portion may permit motion between the seat portion and carriage portion to move in a first direction until the motion in the first direction is mechanically stopped and the wheelchair enters a first metastable state or position and may permit motion between the seat portion and the carriage portion to move in a second direction until the motion in the second direction is mechanically stopped and the wheelchair enters a second metastable state or position.

As used herein, the term metastable means that when the wheelchair is positioned in a metastable state with the weight of the user conventionally distributed on the seat portion, the wheelchair will remain in that position until the seat portion is raised and shifted appropriately to change the wheelchair to the alternate metastable state. For example, in some embodiments, a user may hold the rear wheels substantially in position, push against the rear wheels and lean the upper body forwards, thereby causing the wheelchair to shift from the upright sitting position to the tilt position. Likewise, in some embodiments, the user may hold the rear wheels substantially in position, push backwards against the rear wheels and lean the upper body backwards, thereby causing the wheelchair to shift from the tilt position to the upright sitting position. Alternatively, in some embodiments the user may shift from the upright sitting position to the tilt position and from the tilt position to the sitting position using the arms and shoulders alone, without relying on moving the upper body forwards or backwards.

The seat of the wheelchair may comprise fabric, leather, plastic, or some other flexible material that receives the weight of the user and transfers this weight to a seat frame. The seat frame, the suspension components, and the carriage may be comprised of rigid members. In some embodiments, these load bearing portions of the wheelchair may be made of substantially tubular components such as PVC pipe, aluminum pipe, stainless steel pipe, steel pipe, wooden dowels, and the like. Alternatively, these load bearing portions of the wheelchair may be hollow with a rectangular cross-section solid with atria guitar cross section or other shapes and profiles 95 would be understood by those of still in the art. In an embodiment, the wheelchair is lightweight to promote greater mobility and self-reliance of the user of the wheelchair. For example, a lightweight wheelchair may be more readily manipulated and managed independently by the wheelchair user than a heavier wheelchair. The wheelchair may have two large rear wheels with a circular handrim coupled to each rear wheel to promote the user providing rolling force to the rear wheels. The wheelchair may have two front wheels that are smaller and couple to the carriage of the wheelchair with pivots. These front wheels may be referred to as caster wheels. In some contexts, the wheelchair may be referred to as a manual wheelchair.

In an embodiment, the coupling portion comprises two front struts and two rear struts. Each strut is coupled to a lower axle via a lower pivot and to an upper axle via an upper pivot. For example, each of the two front struts are coupled to a lower front axle that is part of the carriage by a lower pivot and are coupled to an upper front axle that is part of the frame of the seat by an upper pivot. Correspondingly, the two rear struts are coupled to a lower rear axle that is part of the carriage by a lower pivot and are coupled to an upper rear axle that is part of the frame of the seat by an upper pivot. In an embodiment, the two front struts are longer than the two rear struts. In another embodiment, however, the two front struts and the two rear struts are substantially equal in length or the two front struts are shorter than the two rear struts. It will be appreciated that yet other embodiments are consistent with the teachings of the present disclosure. As an example, in an embodiment the coupling portion of the wheelchair may comprise a single front strut and a single rear strut. In an embodiment, the coupling portion may comprise a single front strut and two rear struts. In an embodiment, the coupling portion may comprise two front struts and a single rear strut. In an embodiment, three or more struts may be provided as either front struts or rear struts.

In an embodiment, the carriage of the wheelchair comprises a stop component that provides a stop when the wheelchair is in the sitting upright state and a stop component that provides a stop when the wheelchair is in the tilt state. For example, when the wheelchair is in the sitting upright position, the lower pivot of the rear struts may be stopped from further rotation by a structural bar or block coupled to the carriage. For example, when the wheelchair is in the tilt position, the lower portion of the seat frame may be stopped by the same structural bar or block coupled to the carriage or by another portion of the carriage. One skilled in the art will appreciate that a variety of different stops may be employed. It is understood that a stop may be provided by a component expressly for providing the stopping action or by a component that may provide a second functionality, such as a carriage structural frame element.

The length of the forward struts and the rear struts may readily be determined by one skilled in the art based on a desired amount of positional change between the two metastable states of sitting upright and tilt as well as based on the dimensions of the rear wheels and front wheels.

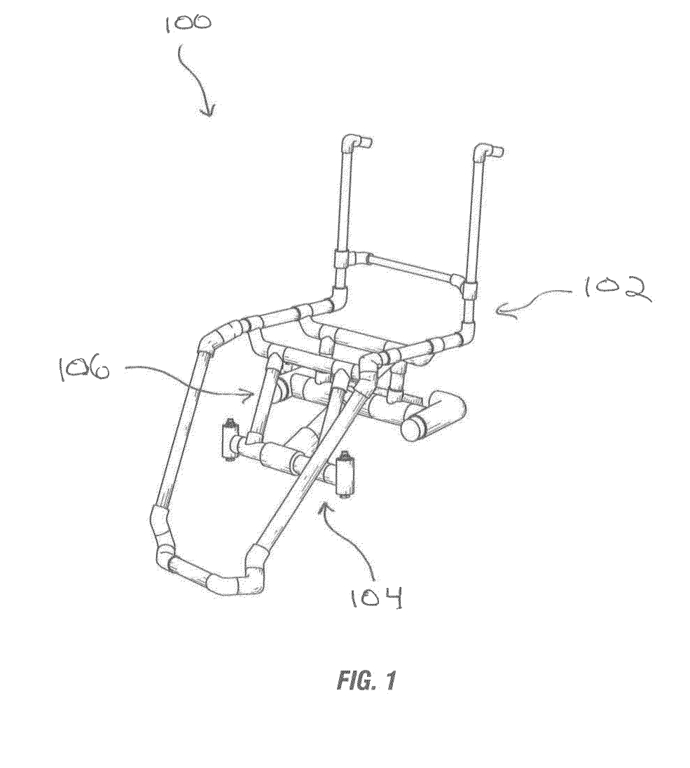

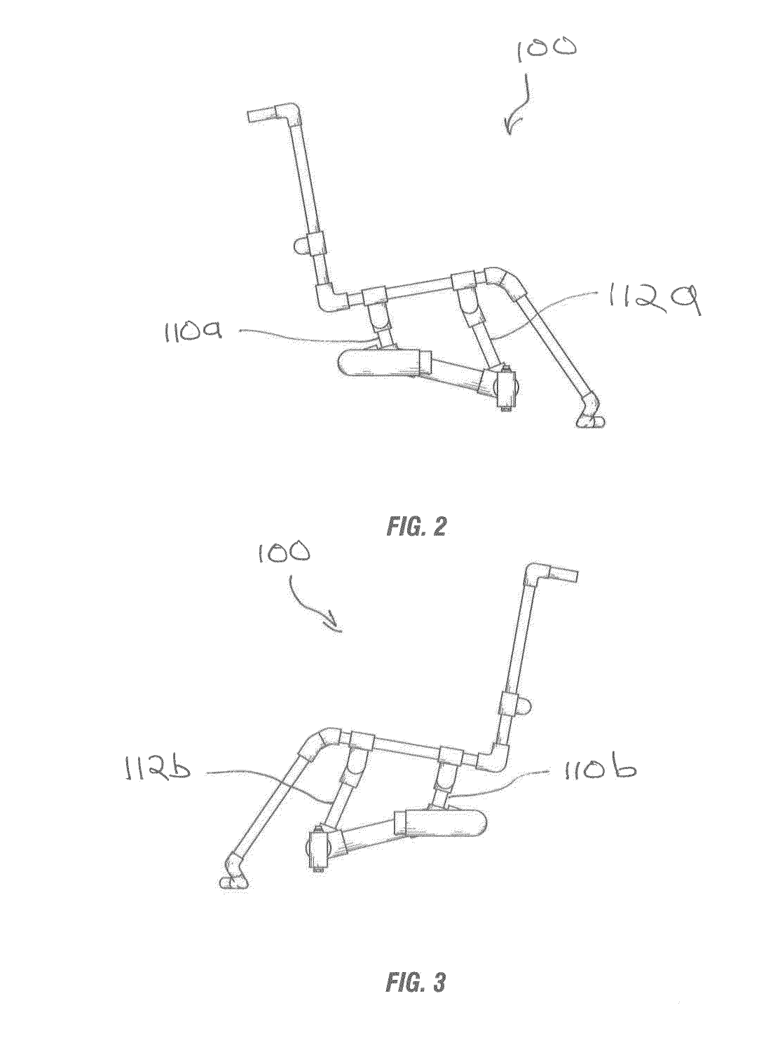

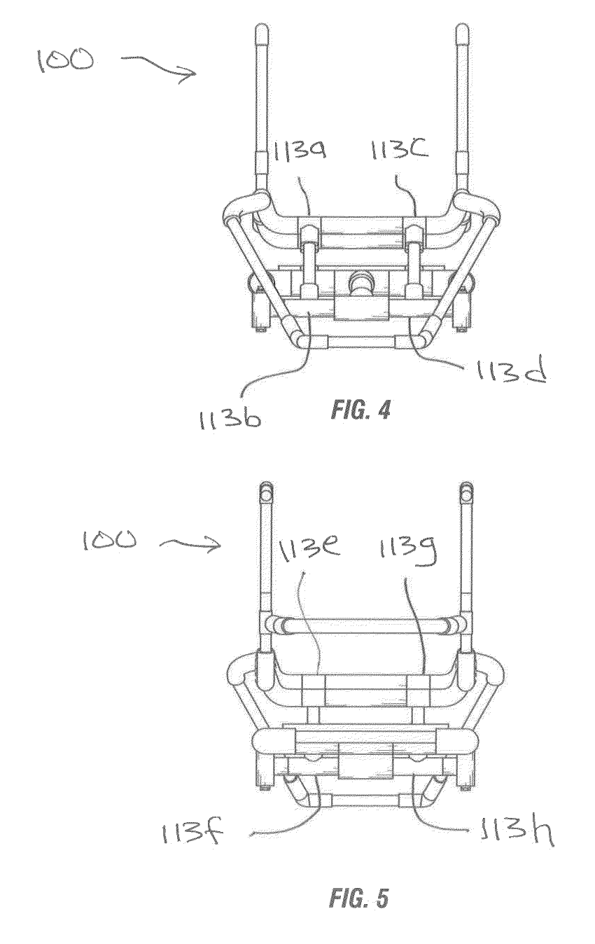

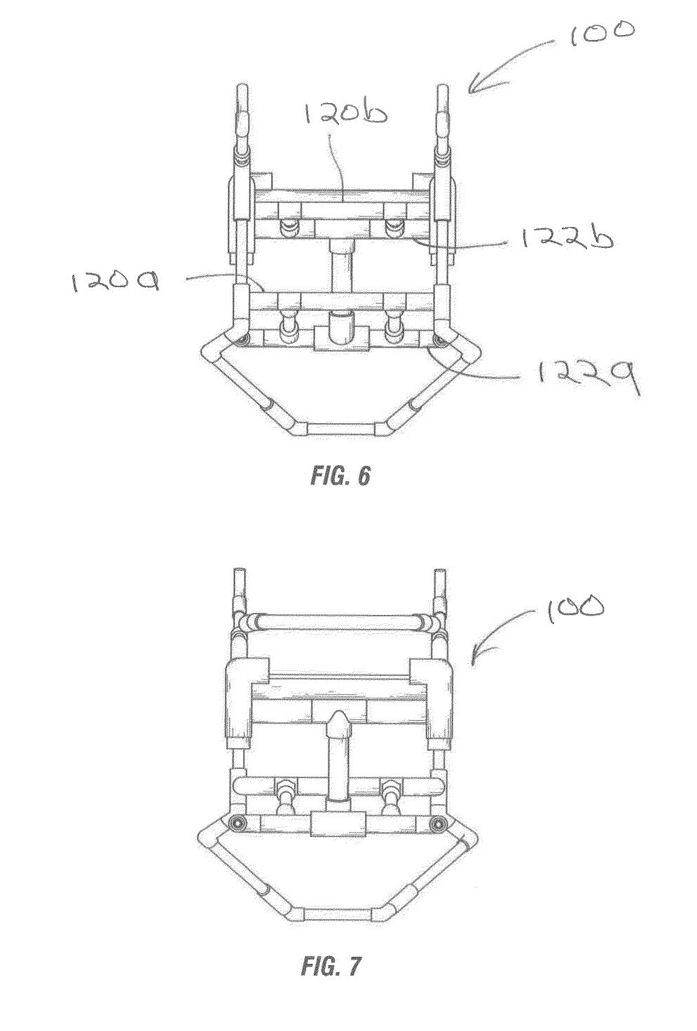

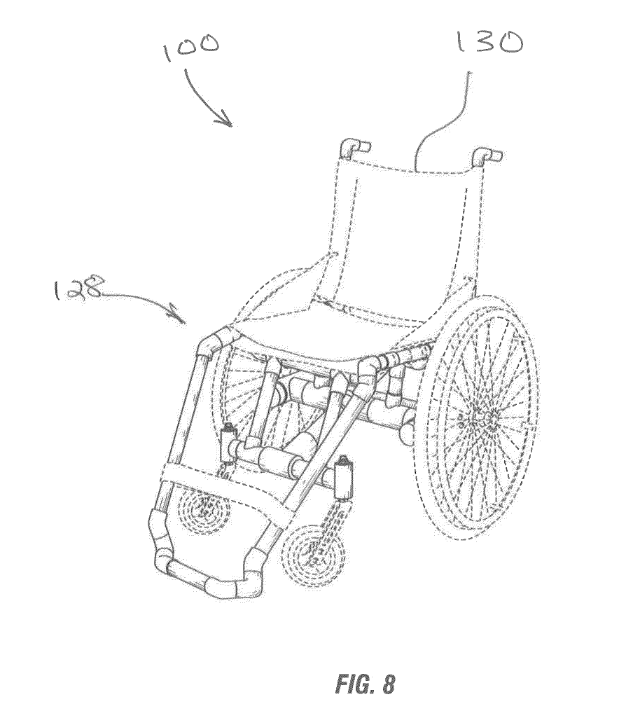

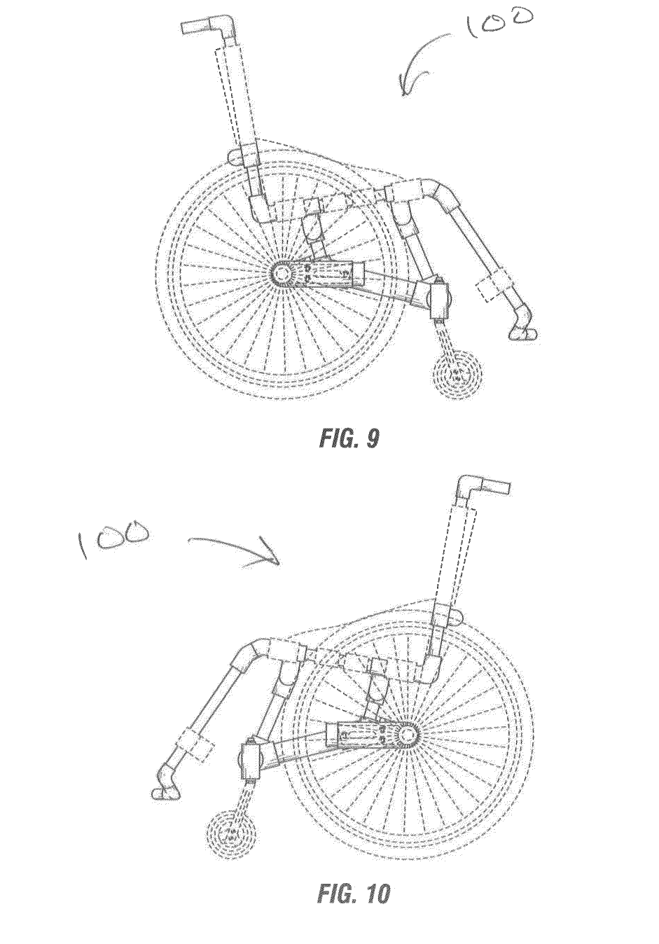

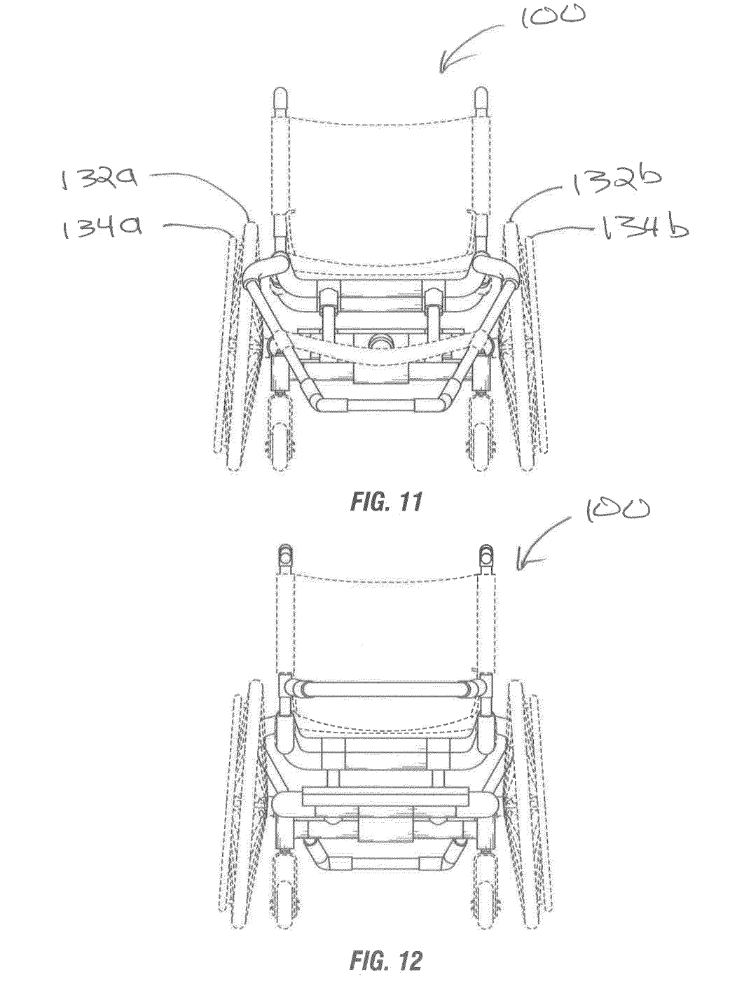

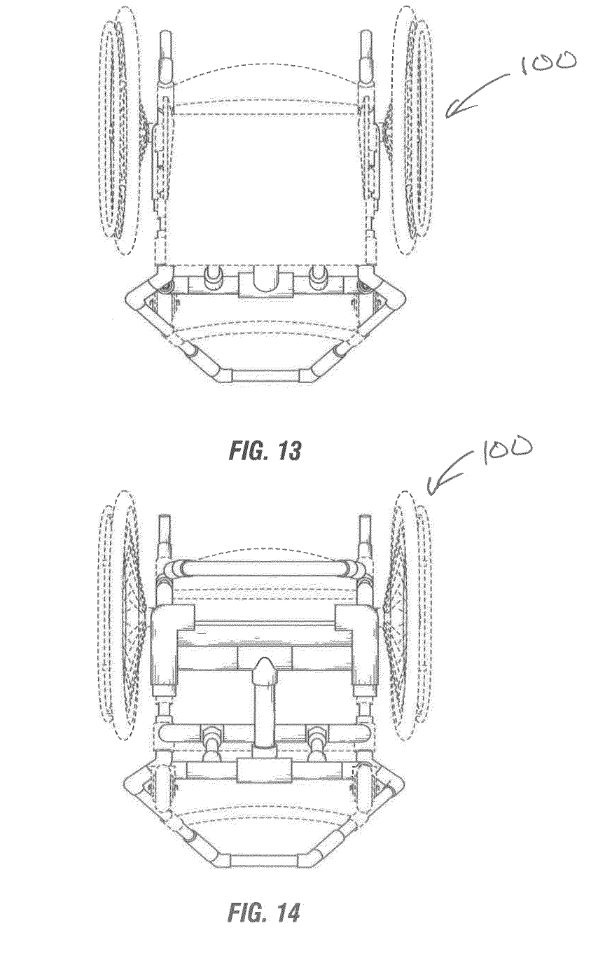

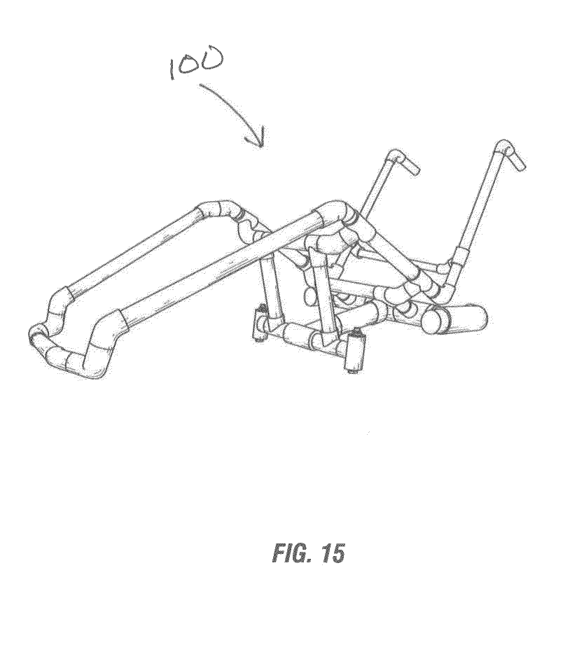

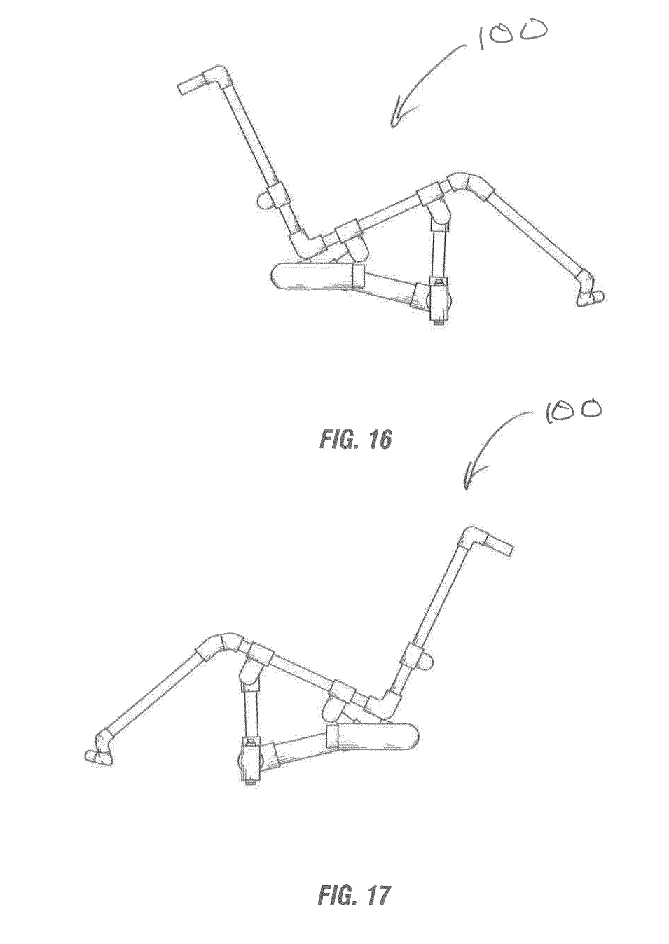

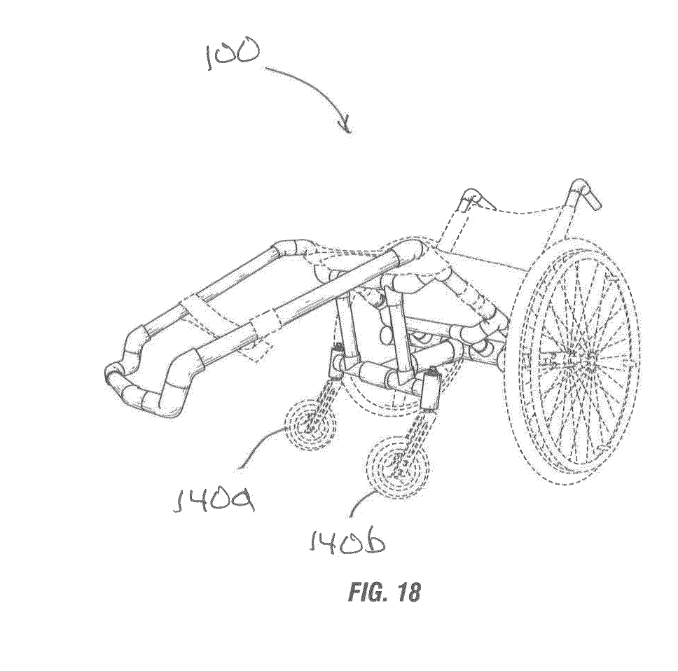

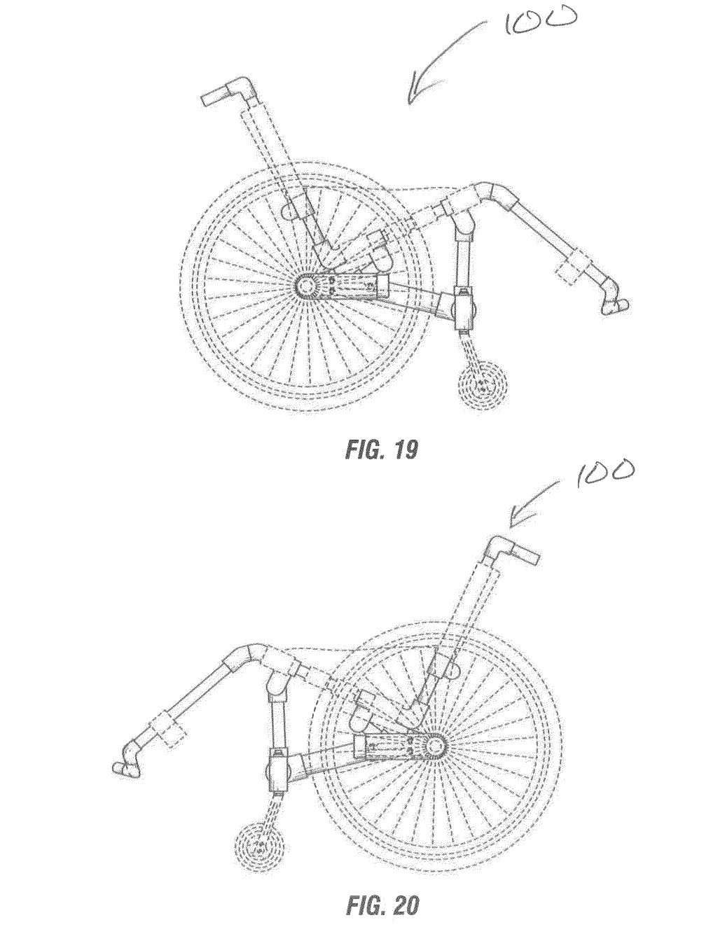

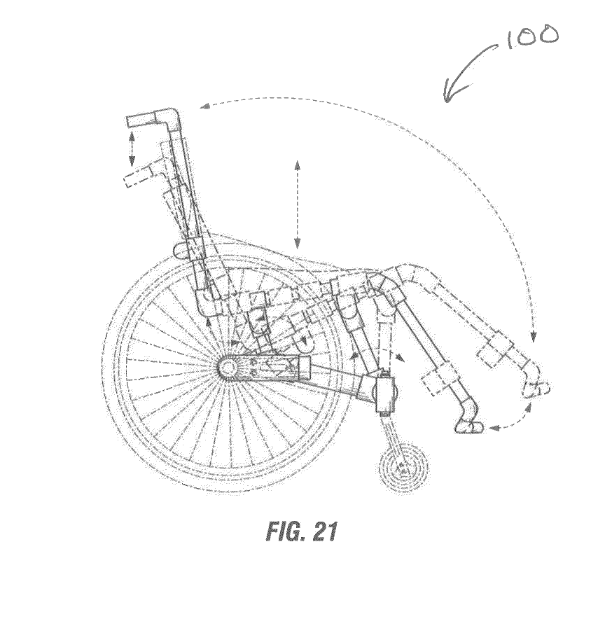

FIG. 1 through FIG. 20 are now described. In an embodiment, a wheelchair 100 comprises a seat portion 128, a carriage portion 104, and a coupling portion 106. The coupling portion comprises a right rear tubular support 110a, a right front tubular support 112a, a left rear tubular support 110b, and a left front tubular support 112b as best seen if FIG. 2 and FIG. 3. Each tubular support is terminated at each of two ends by a pivot 113, as best seen in FIG. 4 and FIG. 5. In an embodiment, the front tubular supports 112 are longer than the rear tubular supports 110. In an embodiment, the front tubular supports 112 are at least twice as long as the rear tubular supports 110. The seat portion comprises a seat frame 102 and a flexible material 130 coupled to the seat frame. The seat frame 102 comprises a front seat coupling axle 120a and a rear seat coupling axle 120b, as best seen in FIG. 6. The carriage 104 comprises a front carriage coupling axle 122a and a rear carriage coupling axle 122b, as best seen in FIG. 6. The wheelchair 100 has two metastable positions, a first metastable position best seen in FIG. 1, FIG. 9, and FIG. 10 and a second metastable position best seen in FIG. 15, FIG. 16, and FIG. 17. The first metastable position may be referred to as an upright position, and the second metastable position may be referred to as a tilt position.

In the first metastable position, the front tubular supports 112 are approximately parallel to the rear tubular supports 110 and the tubular supports 110, 112 are approximately perpendicular to the seat frame 102. These angular relationships among the tubular supports 110, 112 and between the tubular supports and the seat frame 102 are best seen in FIG. 2 and FIG. 3. In the second metastable position, the angular relationship between the front tubular supports 112 and the rear tubular supports 110 relative to each other have changed substantially so in the plane containing the right tubular supports 110a, 112a, the supports 110a, 112a make an angle of greater than 45 degrees with each other and in the plane containing the left tubular supports 110b, 112b, the supports 110b, 112b make an angle of greater than 45 degrees with each other, as best seen in FIG. 16 and FIG. 17. Additionally, the angular relationships between the tubular supports 110, 112 and the seat frame 102 have changed substantially, as best seen in FIG. 16 and FIG. 17. The angular relationships above are understood to be quantified in an approximate way, and the focus is on the changed angular relationships between the tubular supports 110, 112 with each other and with the seat frame 102 in moving between the two metastable positions rather than in the precise quantification of the angular relationships. In an embodiment, the different lengths of the tubular supports 110, 112 in combination with the configuration of the coupling portion 106 drive these angular relationships and provide the upright position and the tilt position.

The wheelchair 100 comprises a right rear wheel 132a, a left rear wheel 132b, a right hand rim 134a coupled to the right rear wheel 132a, and a left hand rim 134b coupled to the left rear wheel 132b. The wheelchair 100 comprises a right front wheel 140a and a left front wheel 140b. In some contexts, the rear wheels 132 may be referred to as large wheels and the front wheels 140 may be referred to as small wheels.

One skilled in the art, after reading the above specification and after studying the accompanying drawings FIG. 1 through FIG. 20, will appreciate that the coupling portion 106, the seat frame 102, and the carriage portion 104 form two 4-bar linkages and more specifically two double rocker mechanisms—a right-hand side rocker mechanism and a left-hand side rocker mechanism. A 4-bar linkage may be said to be formed by a frame link that is substantially fixed or stationary, two grounded links connected to the frame link, and a floating link. A double rocker is a 4-bar mechanism whose grounded links can only move between two limiting angles. In the wheelchair 100 disclosed herein, the double rocker motion is limited by stops at either end of the range of angular motion. For example, the rear tubular supports 110 are stopped against the carriage portion 104 in the upright position as best seen in FIG. 2 and FIG. 3, and the seat frame 102 is stopped against the carriage portion 104 in the tilt position as best seen in FIG. 16 and FIG. 17. The right-hand side rocker mechanism comprises a frame link provided by the right-hand side of the carriage portion 104, the two grounded links connected to the frame link are provided by the right rear tubular support 110a and the right front tubular support 112a, and the floating link is provided by the seat frame 102. The left-hand side rocker mechanism comprises a frame link provided by the left-hand side of the carriage portion 104, the two grounded links connected to the frame link are provided by the left rear tubular support 110b and the left front tubular support 112b, and the floating link is provided by the seat frame 102.

What is claimed is:

1. A wheelchair having two metastable positions, comprising:
a seat portion comprising a seat frame having a front seat coupling axle and a rear seat coupling axle, and a flexible material coupled to the seat frame that transfers a weight of a user to the seat frame;
a carriage portion comprising a front carriage coupling axle and a rear carriage coupling axle; and
a coupling portion comprising
a right front tubular support,
a left front tubular support,
a right rear tubular support, and
a left rear tubular support,
wherein each front tubular support comprises a pivot coupling to the front seat coupling axle and a pivot coupling to the front carriage coupling axle,
wherein each rear tubular support comprises a pivot coupling to the rear seat coupling axle and a pivot coupling to the rear carriage coupling axle,
wherein the right front tubular support, the right rear tubular support, the carriage portion, and the seat frame form a first double rocker mechanism on a right-hand side of the wheelchair;
wherein the left front tubular support, the left rear tubular support, the carriage portion, and the seat frame form a second double rocker mechanism on a left-hand side of the wheelchair;
wherein each of the double rockers is constrained by stops to a range of rocking motion, where the seat portion is in a first metastable position when the double rockers are stopped at a first limit of the range of rocking motion and is in a second metastable position when the double rockers are stopped at a second limit of the range of rocking motion.

2. The wheelchair of claim 1, where in the first metastable position, the seat portion is in an upright position and where in the second metastable position, the seat portion is in a reclined position.

3. The wheelchair of claim 2, wherein the seat portion is maintained in the first metastable position by the weight of the user until work is done to lift the seat portion and shift to the second metastable position and wherein the seat portion is maintained in the second metastable position by the weight of the user until work is done to lift the seat portion and shift to the first metastable position.

4. The wheelchair of claim 1, wherein the pivot couplings comprise an extended sleeve surrounding the axle, and wherein the extended sleeves substantially stabilize each rocker mechanisms to motion in a single plane.

5. The wheelchair of claim 1, wherein the seat frame and the carriage portion comprise tubular structural members, wherein the tubular structural members and the tubular supports are comprised of one of PVC pipe, stainless steel pipe, steel pipe, or aluminum pipe.

6. A wheelchair having two metastable positions, comprising:
a seat portion;
a carriage portion; and
a coupling portion, wherein the coupling portion couples the seat portion to the carriage portion and is configured to restrict a positional relationship between the seat portion and the carriage portion to two metastable positions.

7. The wheelchair of claim 6, wherein the two metastable positions comprise an upright metastable position and a tilt metastable position, whereby a user confined to the wheelchair is able to self-shift from the upright metastable position to the tilt metastable position and to self-shift from the tilt metastable position to the upright metastable position, whereby a risk of the user developing pressure sores from sitting continuously in the same position is attenuated.

8. The wheelchair of claim 6, wherein the seat portion comprises a seat frame and a flexible material coupled to the seat frame that transfers a weight of the user to the seat frame.

9. The wheelchair of claim 8, wherein the wheelchair further comprises
two rear wheels, each rear wheel coupled to the carriage portion;
two handrims, each handrim coupled to a rear wheel; and
two front wheels coupled to the carriage portion.

10. The wheelchair of claim 9, wherein the seat frame, the coupling portion, and the carriage portion comprise hollow pipes.

11. The wheelchair of claim 10, wherein the hollow pipes are formed from lightweight materials.

12. The wheelchair of claim 10, wherein the pipes are formed from one of PVC pipe, aluminum pipe, stainless steel pipe, or steel pipe.

13. The wheelchair of claim 10, wherein the pipes are one of circular in cross-section, triangular in cross-section, or rectangular in cross-section.

14. A method of shifting between two metastable positions in a wheelchair, comprising:
leaning forward in the wheelchair by an occupant of the wheelchair;
gripping a rear wheel of the wheelchair or a wheel rim of the wheelchair by a hand of the occupant of the wheelchair; and
pushing against the rear wheel or wheel rim with the hand by the occupant of the wheelchair,
whereby the wheelchair is shifted from a first metastable position to a second metastable position.

15. The method of claim 14, further comprising when the wheelchair is in the second metastable position, pushing against the rear wheel or wheel rim with the hand by the occupant of the wheelchair, whereby the wheelchair is shifted from the second metastable position to the first metastable position.

16. The method of claim 15, wherein when the wheelchair is in the second metastable position, pushing backwards against the rear wheel or wheel rim with the hand by the occupant of the wheelchair.

17. The method of claim 14, wherein the wheelchair comprises
a seat portion;
a carriage portion; and
a coupling portion, wherein the coupling portion couples the seat portion to the carriage portion and is configured to restrict a positional relationship between the seat portion and the carriage portion to two metastable positions.

18. The method of claim 17, wherein the seat portion comprises a seat frame having a front seat coupling axle and a rear seat coupling axle, and a flexible material coupled to the seat frame that transfers a weight of a user to the seat frame.

19. The method of claim 18, wherein the carriage portion comprises a front carriage coupling axle and a rear carriage coupling axle;

20. The method of claim 19, wherein the coupling portion comprises
a right front tubular support,
a left front tubular support,
a right rear tubular support, and
a left rear tubular support,
wherein each front tubular support comprises a pivot coupling to the front seat coupling axle and a pivot coupling to the front carriage coupling axle,
wherein each rear tubular support comprises a pivot coupling to the rear seat coupling axle and a pivot coupling to the rear carriage coupling axle,
wherein the right front tubular support, the right rear tubular support, the carriage portion, and the seat frame form a first double rocker mechanism on a right-hand side of the wheelchair;
wherein the left front tubular support, the left rear tubular support, the carriage portion, and the seat frame form a second double rocker mechanism on a left-hand side of the wheelchair;
wherein the each of the double rockers is constrained by stops to a range of rocking motion, where the seat portion is in the first metastable position when the double rockers are stopped at a first limit of the range of rocking motion and is in the second metastable position when the double rockers are stopped at a second limit of the range of rocking motion.
